(19) United States
(12) Patent Application Publication
(10) Pub. No.: US 2009/0090155 A1
(43) Pub. Date: Apr. 9, 2009

(54) Sheet-Metal Working Machine and Method for Machining Sheets

(75) Inventor: Jose Andre Cornelius Coopman, Ieper (BE)

Correspondence Address: BACON & THOMAS, PLLC, 625 SLATERS LANE, FOURTH FLOOR, ALEXANDRIA, VA, 22314-1176, US

(73) Assignee: ROBOSOFT, NAAMLOZE VENNOOTSCHAP, Ieper (BE)

(21) Appl. No.: 11/920,643

(22) PCT Filed: May 19, 2006
(86) PCT No.: PCT/BE2006/000054

§ 371 Date: Oct. 29, 2008

(30) Foreign Application Priority Data
May 19, 2005 (BE) 2005/0247

(51) Int. Cl. B21D 11/00; B66C 1/00; B21D 43/11

(52) U.S. Cl. 72/323; 294/67.31; 72/422

(57) ABSTRACT

Improved sheet-metal working machine comprising at least one manipulator for manipulating metal sheets (25), characterised in that the manipulator is provided with at least one stop surface (22-24) against which sheet-metals (25) which are manually supplied can be positioned.

The present invention concerns an improved sheet-metal working machine, in particular an improved edging press, folding bench or cutting bench or the like for folding or cutting metal sheets.

The present invention also concerns a method for machining sheets.

Edging presses and folding benches are used to fold metal sheets and to transform them into three-dimensional work pieces, such as for example housings of electronic equipment.

A conventional edging press mainly consists of a fixed socle on the one hand on which is provided a table and lower tools, and a moving ram provided on top of it with clamping means and upper tools on the other hand. Such a known edging press is usually called an edging press with downward ram.

On the other hand, also an edging press with rising table is known, whose underlying table can be moved up and down, whereas the upper tools are immobile.

Folding benches, on the other hand, mainly consist of a table with a fixed part and a rotating member. A metal sheet which is applied on it in an appropriate manner, is folded by holding one part on the fixed part of the table and by making a second part of the metal sheet rotate along with the rotating member of the table.

On the other hand, there are cutting benches which are used to cut metal sheets.

Cutting benches mainly consist of a table on the one hand, with a lower knife provided on it, and a moving ram with an upper knife on the other hand. A metal sheet is cut by putting it on the table in an appropriate manner and by subsequently moving the upper knife down.

For a correct positioning of a plate in relation to the tools, the above-mentioned devices are provided with a stop which, provided it is set correctly, guarantees a correct positioning of the metal sheet.

Indeed, by setting a stop as a reference for the metal sheet, the operator, i.e. the worker operating the sheet-metal working machine, can place the metal sheet in a precise and efficient manner up against the set stop, such for a whole series of identical metal sheets to be machined.

Such a known stop usually consists of two fingers which can be each positioned in three mutually perpendicular directions.

More particularly, the two fingers are provided with a recess forming a stop for the metal sheet. The two fingers can be independently adjusted in a vertical manner and they can be placed horizontally and parallel to the tools, away from each other or closer to each other or further away from the tools.

The side of the sheet-metal working machine where the stop is provided is usually called the back of the machine, and the above-described and known stop is called a back stop.

In the further description we will each time refer to said edging presses, but of course the invention can also be applied to a folding bench or a cutting bench or any other sheet-metal working machine.

Known edging presses are provided with two massive side walls which, on the one hand, connect to the table and upward to the supporting columns and/or form the guide for the up and down moving ram if there is one, and on the other hand guarantee the stability of the edging press as they reach next to or even past the aforesaid stop, i.e. what is called the back stop. In other words, the side walls are directed towards the back.

The aforesaid known edging presses are often operated by an operator who first sets the back stop, either manually or in an automated manner, and who subsequently pushes the metal sheet up against the back stop, after which he will operate the edging press so as to perform a folding operation.

In some cases, the operator is replaced by a robot arm, and the metal sheets are then manipulated entirely automatically.

In that case, the robot arm is provided at the front of the edging press.

The problem is that the robot needs to be moved if, for example, in order to fold a small series of metal sheets, it is more indicated to have the metal sheets manipulated by an operator.

Moreover, the presence of the robot arm makes it impossible for an operator to be present while it is operational, even for small interventions, for safety reasons.

Another problem is that the fingers of such a known back stop can only be positioned at a distance from the side edges of the table, as a result of which their action is limited of course.

For, in some cases, it is indicated to perform the folding near the side edges of the table, but the restricted positioning freedom of the stop there restricts the possibilities of the edging press.

Indeed, the side walls are provided at a distance from the side edges of the table, and the fingers of the stop can be provided only at a distance from the side walls.

Another problem consists in that the stop surfaces of the fingers of a common back stop are always directed in the same direction, for example horizontally and parallel to the tools, as a result of which the work piece cannot always be efficiently machined in any desired direction.

The invention aims to efficiently solve the aforesaid and other problems; to that end, the improved sheet-metal working machine comprises at least one manipulator for manipulating metal sheets, whereby the manipulator is provided with at least one stop surface against which metal sheets, which can be supplied manually, are placed, comprising at least one manipulator for manipulating sheets and also comprising a stop against which sheets can be placed, characterised in that the stop is provided on the manipulator.

A major advantage consists in that the common back stop, which is provided with a common sheet-metal working machine, is no longer necessary and thus can be omitted.

Integrating such a stop on the manipulator is an important money-saver if the edging press would in any case be provided with a manipulator, for example a robot arm, to manipulate the metal sheet.

On the other hand, integrating such a stop on the manipulator makes the purchase of for example a robot arm more justified, as a result of which the automated folding of metal sheets becomes more generally accessible.

As the stop can be omitted, this allows not only for savings in a financial manner of speaking, it also helps to save space.

Indeed, the space that is usually occupied by a common back stop, i.e. in the case of an edging press the space between its side walls, is available now and the aforesaid manipulator or the robot arm can be put there.

This enables us to make the sheet-metal working machine work in an entirely automated manner on the one hand, and to have it function in co-operation with an operator who applies the metal sheet on one side of the sheet-metal working machine on the other hand, and whereby the manipulator on the other side of the sheet-metal working machine serves as a stop.

This offers certain advantages for small series, since the manipulations do not need to be programmed in that case, which is indeed more cost-effective for small series.

The manipulator, either or not in the shape of a robot arm, must not be moved when an operator intervenes. Even for small interventions, an operator can safely move in front of the sheet-metal working machine, even while the manipulator and the sheet-metal working machine are operational.

It should be noted that the manipulator and the stop provided on it are situated on the front side of the sheet-metal working machine, where the manipulator has more space to manipulate for example large sheet-metals.

The invention in particular concerns an improved edging press, an improved folding bench or cutting bench, comprising at least one manipulator for manipulating sheets and also comprising a stop against which sheets can be placed, whereby the stop is provided on the manipulator.

The invention also concerns a method for machining sheets, in particular metal sheets, whereby an operator supplies a metal sheet to a sheet-metal working machine which is provided with a manipulator, whereby the manipulator is provided with at least one stop surface and whereby the manipulator, in co-operation with the operator, positions itself such that the stop surface serves as a stop for positioning the metal sheet.

In order to better explain the characteristics of the invention, the following preferred embodiment of an improved sheet-metal working machine, in this case an improved edging press, is given as an example only without being limitative in any way, with reference to the accompanying drawings, in which:

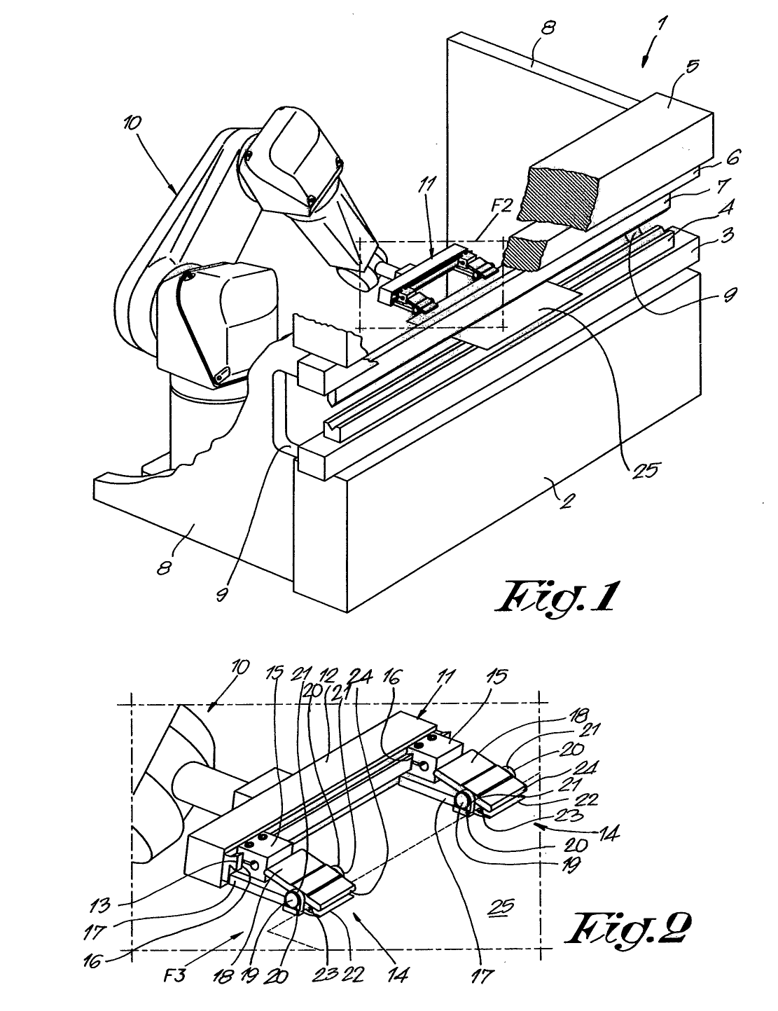

FIG. 1 schematically represents a preferred embodiment of an improved edging press according to the invention, seen in perspective;

FIG. 2 represents the part indicated by F2 in FIG. 1 to a larger scale;

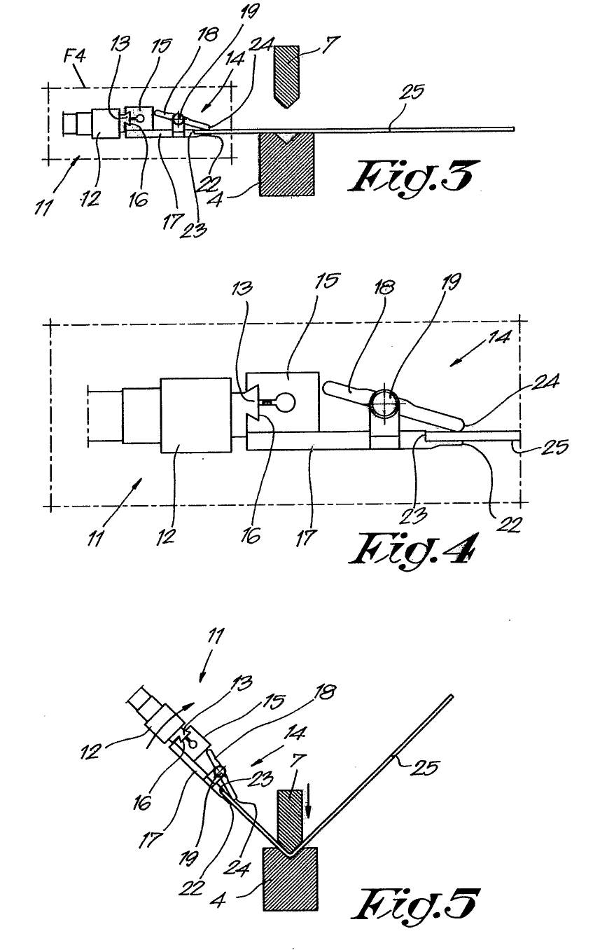

FIG. 3 represents a view according to arrow F3 in FIG. 2;

FIG. 4 represents the part indicated by f4 in FIG. 3 to a larger scale;

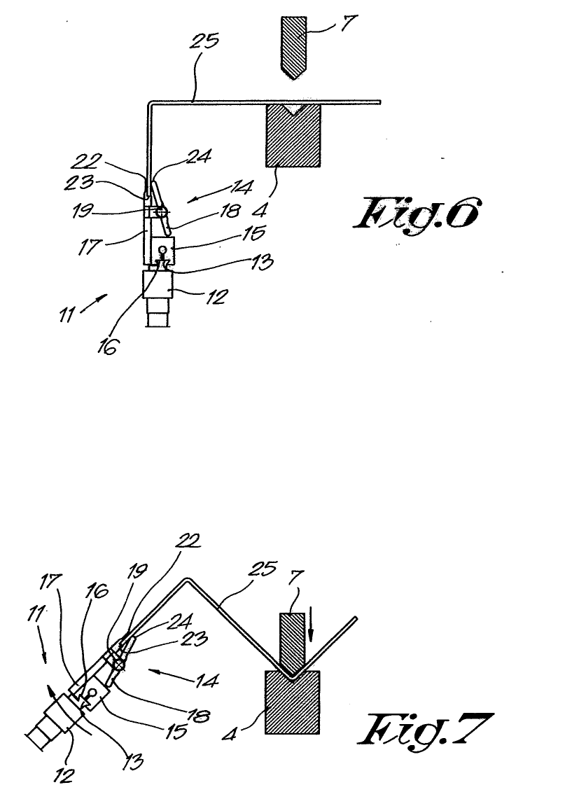

FIGS. 5 to 7 represent the part as represented in FIG. 3, but for different positions of the improved edging press.

FIG. 1 represents a preferred embodiment of an edging press 1 according to the invention, which mainly consists of a fixed socle 2 on which is provided a table 3 and a lower tool 4.

Further, the edging press 1 is provided with a moving ram 5, in particular an upper downward ram 5 on which are provided clamping means 6 and an upper tool 1.

The moving ram 5 is fixed on two side walls 8 made of massive steel and which extend on one side of the table 3 from the floor up to a height near the ram 5. The side along which the side walls 8 are provided is usually called the back side of the edging press 1.

De side walls 8 are provided with a large recess 9 near the connection with the lower tool 4. These recesses 9 are well known and are called the “col de signe” in technical jargon.

The edging press 1 is provided with a manipulator according to the invention which in this case consists of a common robot arm 10 with six degrees of freedom on which is provided a gripper 11.

The gripper 11 mainly consist of a beam element 12 with a dovetail tooth profile 13 in this case on which two fingers 14 can slide.

The two fingers 14 consist of sliding fastening blocks 15 in which is provided a dovetail groove profile 16 and against which a protruding supporting plate 17 is each time provided.

On each of these supporting plates 17 is provided a little plate 18, in particular in a tilting manner and by means of a shaft 19 which is fixed to the little plate 18 and whose far ends 20 can rotate in two lateral supports 21 provided on each of the supporting plates 17.

The little plates 18 are moreover reinforced by means of pneumatic piston cylinders that are not represented in the drawings.

The supporting plates 17 are mainly flat, but between the aforesaid lateral supports 21 and the free ends 22 of the supporting plates 17, they are provided with recesses 23 at the top defining two stop surfaces and which have for a result that the supporting plates 17 gradually become thinner towards their free ends 22.

The free ends 22 of the supporting plates 17 practically coincide with the free ends 24 of the little plates 18, which free ends also form stop surfaces of the manipulator.

The working of the above-described improved edging press according to the invention is simple and as follows.

If the edging press 1 works fully automatically, the robot arm 10 will serve as a manipulator of the metal sheets 25.

The edging press 1 and the robot arm 10 are controlled in a co-ordinated and fully automatic manner, at least after the specifications of the metal sheet 25 to be folded and the desired end product have been inputted in the central control unit of the edging press 1.

The robot arm 10 is programmed in the control software of the improved edging press 1, in the same manner as a conventional edging press with a conventional motorized back stop.

As soon as it is programmed, the robot arm 10 can pick up a metal sheet 25, to which end the gripper 11 will be appropriately directed to the supplied metal sheets 25, the little plates 13 will be tilted by the control of the aforesaid pneumatic cylinders, and the gripper 11 will be moved in relation to the metal sheets 25 until the metal sheet 25 rests against the recess 23.

The little plates 18 are then tilted into their closed position again, such that the metal sheet 25 is being gripped.

The robot arm 10 places and subsequently maintains the metal sheet 25 in an appropriate manner between the lower tool 4 and the upper tool 7 of the edging press 1.

The ram 5 is then moved down, such that the plate 25 is folded.

The gripper 11 will possibly grip the sheet 25 in another position. It realises this transition immediately after having performed a folding operation, in particular when the sheet is still being held between the aforesaid tools.

Next, the ram 5 is moved up and the robot arm 10 re-positions the sheet 25 between the aforesaid tools.

These steps are repeated until the sheet 25 has been transformed into the aimed three-dimensional work piece.

The up-and-down movement of the ram 5 is, as customary, hydraulically reinforced.

When the work piece is finished, it is put in an assigned place by the robot arm 10 and a new cycle is started.

It should be noted that, in the above-described fully automatic regime, the robot arm 10 with the gripper 11 functions as a manipulator.

If the edging press 1 is operated by an operator, the operator will take place on the side opposite the side where the robot arm 10 is placed.

The operator will manually pick up a metal sheet 25 and position this sheet 25 correctly between the lower tool and the upper tool 7.

To this end, the operator gets help from the robot arm 10 with the gripper 11 which will serve as a stop here.

Indeed, the free ends 22 of the supporting plates 17, the free ends 24 of the little plates 18 or possibly the recesses 23 are positioned such that they can form stop surfaces for the sheet 25.

For every folding operation that the operator wishes to perform on a metal sheet 25, the robot arm 10 will reposition itself in an appropriate manner. The operator may give a command to that end, or this may happen according to a certain preset sequence whose frequency may possibly be automatically adjusted.

For special folding operations, it may be necessary for the sheet 25 to be folded on the side edge of the table 3, and to that end the robot arm 10 may guide a possible specific gripper 11 partly through a recess 9 or what is called a “col de signe”.

It is clear that the robot arm 10 can also be placed on the front side of the edging press, and that a possible operator takes place at the back of the edging press 1 in that case.

Moreover, it is clear that the construction of the conventional edging press 1 with the side walls 8 along one side of the table 3 is now merely arbitrary, since the conventional stop is now replaced by a robot arm.

It is clear that the robot arm 10 can also be provided with less or more degrees of freedom and that the gripper 11 may be built differently.

Apart from a pneumatic reinforcement, the gripper 11 can also be provided with a hydraulic or a mechanical reinforcement, or the gripper 11 may contain magnets or pistons to hold the sheet 25.

As mentioned above, it is clear that integrating a stop surface on a manipulator for manipulating the sheet-material can also be applied to a folding bench or a cutting bench.

Moreover, one robot arm may possibly serve as a manipulator for more than one sheet-metal working machine, for example placed between an edging press 1 and a cutting bench.

It should be noted that, per sheet-metal working machine, also several robot arms 10 or manipulators can be provided, of which at least one is provided with a gripper 11 according to the invention on which is provided a stop surface.

The present invention is by no means limited to the embodiments given as an example and represented in the figures; on the contrary, such an improved sheet-metal working machine can be made according to several variants while still remaining within the scope of the invention.

1. Sheet-metal working machine comprising at least one manipulator for manipulating metal sheets, wherein the manipulator includes at least one stop surface against which sheet-metals which are manually supplied to the manipulator can be positioned.

2. Sheet-metal working machine according to claim 1, wherein the manipulator is provided with control means which enable use of the manipulator, depending on the circumstances, as both a manipulator of metal sheets, and a stop against metal sheets manually supplied to the manipulator can be positioned.

3. Sheet-metal working machine according to claim 1, said sheet-metal working machine including an edging press with a downward ram, an edging press with a rising table, and a folding bench or a cutting bench.

4. Sheet-metal working machine according to claim 1, wherein the manipulator is provided with four or more degrees of freedom.

5. Sheet-metal working machine according to claim 1, wherein the manipulator is a robot arm.

6. Sheet-metal working machine according to claim 1, wherein the manipulator comprises at least one gripper and said at least one stop surface is provided on the gripper.

7. Sheet-metal working machine according to claim 6, wherein the gripper is provided with at least one finger which is provided with said at least one stop surface near its free end.

8. Sheet-metal working machine according to claim 6, including a gripper comprising a mechanical grip which is pneumatically, hydraulically or mechanically assisted.

9. Sheet-metal working machine according to claim 6, wherein the gripper comprises at least one pneumatic piston.

10. Sheet-metal working machine according to claim 4, including a gripper comprising a magnet.

11. Sheet-metal working machine according to claim 1, wherein the sheet-metal working machine comprises an edging press comprising a fixed socle on which is provided a table and a lower tool, a moving ram with a clamping device and an upper tool, and wherein the edging press includes two side walls extending along one side of the table from the floor up to a height near the ram, and the manipulator is provided between the side walls.

12. Sheet-metal working machine according to claim 1, wherein the sheet-metal working machine comprises an edging press which includes a fixed socle on which are provided a table and a lower tool, a moving ram with a clamping device and an upper tool, and wherein the edging press further includes two side walls extending along one side of the table from the floor up to a height near the ram, and the manipulator is located between the side walls.

13. A process for using a sheet metal workpiece manipulator of a sheet metal-working machine including using the manipulator as a stop when a metal sheet workpiece is manually inserted in the sheet-metal working machine.

14. Method for machining metal sheets, wherein an operator supplies a metal sheet to a sheet-metal working machine which is provided with a manipulator, including the steps: providing the manipulator with at least one stop surface and positioning the manipulator such that the stop surface serves as a stop for positioning the metal sheet.
